(19) United States
(12) Patent Application Publication
(10) Pub. No.: US 2023/0363592 A1
(43) Pub. Date: Nov. 16, 2023

(54) ARRANGEMENT WITH A ROUND BRUSH

(71) Applicant: Karl Werner STRASSER, Spittal an der Drau (AT)

(72) Inventor: Karl Werner STRASSER, Spittal an der Drau (AT)

(21) Appl. No.: 18/014,908

(22) PCT Filed: Jul. 7, 2021
(86) PCT No.: PCT/EP2021/068787

§ 371 Date: Jan. 6, 2023

(30) Foreign Application Priority Data
Jul. 9, 2020 (AT) A 50594/2020

(51) Int. Cl. A47K 7/04; A46B 13/00; A46B 9/02; F03B 17/06

(52) U.S. Cl. CPC A47K 7/046; A46B 13/001; A46B 9/026; F03B 17/06; A46B 2200/1006

(57) ABSTRACT

An arrangement for cleaning feet has a round brush that is driven in rotation. The water-operated rotary drive is arranged on a carrier that is designed as housing. Water exits in the area of the shaft of the round brush from the rotary drive to the round brush. A U-shaped stirrup is fastened to the housing, which stirrup is arranged above the round brush in such a way that the upper area of the round brush projects through the stirrup. The feeding of water to the rotary drive is regulated by a shut-off device, which is actuated by a pedal. The pedal is arranged between a base of the housing and the round brush.

### CROSS-REFERENCE TO RELATED APPLICATIONS

This application is the U.S. national phase of International Application No. PCT/EP2021/068787 filed Jul. 7, 2021 which designated the U.S. and claims priority to AT A 50594/2020 filed Jul. 9, 2020, the entire contents of each of which are hereby incorporated by reference.

### BACKGROUND OF THE INVENTION

### Field of the Invention

The invention relates to an arrangement with a round brush, with a rotary drive for the round brush, wherein the rotary drive has a motor that is preferably driven by flowing water.

### Description of the Related Art

A round brush, which is rotated by a motor driven by flowing water, is known from U.S. Pat. No. 7,762,762 B2. The water exits from openings that are provided in the wall of a chamber that holds the rotor and is fed to the round brush from outside. An embodiment of a device with a rotating nozzle head that is designed like a fountain is also known in U.S. Pat. No. 7,762,762 B2. The nozzle head is rotated and exposed to water pressure by its high shaft.

A hydraulic motor for driving rotating tools is known from U.S. Pat. No. 6,702,038 B1. As tools, i.a., round brushes are mentioned. The water, which drives the motor, exits the housing of the motor laterally through openings and is fed to the round brush. It is proposed to provide a sleeve in order to improve the feeding of water to the round brush.

A system that is driven by a hydraulic motor (turbine) with a round brush is also known that is marketed under the name “Renovator.” The round brush can be used for animal care, washing cars, and the like. This handheld round brush is rotated by a water-driven turbine. Water exits from the brush-side end of the turbine housing in the form of water jets moving in a circle.

### SUMMARY OF THE INVENTION

The object of the invention is also to form an arrangement of the above-mentioned type so that it can advantageously be used for washing feet.

This object is achieved according to the invention with an arrangement that has the features disclosed herein.

The arrangement according to the invention can be used without the assistance of third parties when the individual whose feet are to be washed is, for example, physically disabled.

Since, in the arrangement according to the invention, the round brush is arranged on a carrier with a rotary drive, it can be set up, fastened, or incorporated anywhere. Because of the stirrup that is provided in the arrangement according to the invention, which stirrup is arranged on the carrier, it is possible to rest the foot on the stirrup during washing, in particular when the sole of the foot is to be washed. Thus, excessive loads on the round brush itself are avoided. This advantageously occurs in particular when the stirrup is provided in the area of the round brush above the axis of rotation of the round brush.

Nevertheless, in the arrangement according to the invention, the round brush is easily accessible, so that the toes and the top of the foot (the instep) and also the heel area can be easily washed, since the round brush below the stirrup is accessible from either side, from the bottom and from the front.

In one embodiment, the stirrup is an essentially U-shaped stirrup, which has the advantage that the stirrup can be adapted to the shape of the round brush.

In a practical embodiment, the stirrup is fastened via its shank to the carrier of the arrangement, so that sufficient stability is provided.

In a practical embodiment, the crosspiece of the stirrup is curved, in particular curved essentially in the shape of an arc of a circle, so that the shape of the stirrup can be easily adapted to the shape of the round brush.

Within the framework of the invention, it is especially advantageous when the shaft, and thus the axis of rotation, of the round brush is oriented essentially horizontally, and the stirrup is also essentially horizontal when the arrangement is in its operating position.

In order to make it as easy as possible to clean the bottom of a foot (sole of the foot), it can be provided in one embodiment of the arrangement according to the invention that the upper part of the round brush extends through the stirrup and projects upward over the stirrup.

When it is provided according to a proposal of the invention that the free end of the round brush that is opposite to the rotary drive projects over the, for example curved, crosspiece of the stirrup, the free end of the round brush is easily accessible and makes it possible to wash feet in the toe area and in the instep area.

In a practical embodiment, it is provided that the stirrup has a width that is essentially equal in value to the diameter of the round brush.

In a practical embodiment, the carrier is designed as a housing, so that fixtures (shut-off devices and control devices) and lines can be accommodated inside the housing.

When the arrangement according to the invention is to be set up, the carrier has a base.

Also, the installation of the arrangement according to the invention in a shower or the like is possible. The embodiment with the base makes possible not only the free setting-up of the arrangement according to the invention but also concealed wiring of the arrangement according to the invention before tiles are laid.

For example, holes are provided in the base through which screws can be inserted in order to fasten the arrangement to, for example, a subfloor made of concrete, tile, or wood. When the arrangement is to be set up outdoors, screw pegs can be used for fastening.

In order to make the bottom of the round brush easily accessible when cleaning the top (the instep) of the foot, it is provided in one embodiment of the invention that there is a free space between the base and the round brush.

In order to supply the arrangement according to the invention with water, for example from a water line, it can be provided that a connector for flowing water is provided on the housing and that a line is provided that runs from the connector to the motor, which is, for example, a turbine, of the rotary drive.

In one embodiment of the invention, it is provided that a container with at least one space for liquid soap and/or sanitizer is assigned to the housing. This makes it possible to configure the washing of feet more effectively and/or to sanitize feet, for example after washing.

In this embodiment, it has turned out to be good practice that, when provided, the container is removably attached to the housing.

In order for the liquid soap and/or sanitizer to be able to exit through the stirrup, it can be provided in one embodiment of the invention that the stirrup is hollow and outlet openings for liquid soap and/or sanitizer are provided in the stirrup. These outlet openings are provided in a preferred embodiment on the lower side of the stirrup in the operating position of the arrangement.

In this case, according to a proposal of the invention, it can be provided that the outlet openings are designed as nozzles or are provided with nozzles.

An especially simple way of attaching the container is for at least one connector for a container to be provided on the housing, in particular on its upper wall in the operating position, so that the medium that is contained in the container can be easily fed. In this case, it has turned out to be good practice that when at least one line is provided according to a proposal of the invention, at least one of the shanks of the stirrup should run from the connector to the housing to the end that is fastened to the housing.

In order to improve the feeding of cleaning agent (liquid soap) and/or sanitizer, the container can be equipped with a pump that can be actuated by a pressing button, which is designed, for example, as a deformable bellows.

In order to simplify the refilling of cleaning agents and/or sanitizer, it is provided in one embodiment that the container has a preferably closable fill opening.

In order to improve the stability of the arrangement according to the invention, the carrier, in particular the housing of the arrangement, can be connected to a plate that is arranged on the side of the carrier that is opposite to that of the round brush.

In one embodiment of the invention, it can be provided that the carrier and/or the base of the arrangement according to the invention is/are made of plastic-coated metal parts (metal plates).

When, according to a proposal of the invention, the motor of the rotary drive is a turbine that is driven by flowing water, the action of a friction clutch is produced, which clutch prevents damage to the motor when the round brush is inadvertently halted, i.e., is motionless.

In one embodiment of the invention, water exits through an opening on the round-brush-side end of the motor housing, through which opening the shaft of the round brush is also guided. Water thus moves effectively into the radial inner area of the round brush and is well distributed.

In a preferred embodiment of the arrangement according to the invention, it is advantageous that water with a flow exits from the opening of the motor housing, through which the shaft of the round brush projects, with a flow that is oriented essentially parallel to the axis of rotation (axis of the shaft of the round brush).

In addition, in a preferred embodiment of the arrangement according to the invention, it is advantageous that water exits from the opening of the motor housing, through which the shaft of the round brush projects, into the area of the shaft of the round brush.

For example, water exits from the motor housing through an annular gap, which is provided between the shaft of the round brush and the opening of the motor housing, through which the shaft of the round brush projects, in the direction toward the round brush.

In order to configure the feeding of water to the round brush more effectively, it can be provided that the shaft of the round brush is designed to be hollow and that openings are provided in the wall of the shaft. In this embodiment, a part of the water that exits from the motor housing enters into the hollow shaft, so that the inside space of the shaft is exposed to water pressure. Thus, a uniform feeding of water to the round brush is possible, since the inside space of the shaft communicates (indirectly) with the inside space of the motor housing of the rotary drive.

In a practical embodiment, it can be provided that the carrier is part of a shower panel, a bidet, or a shower tray.

In addition, there is the possibility of integrating the arrangement according to the invention into a, for example, free-standing backyard shower. In this case, the arrangement can be supplied with water via a garden hose.

In a practical embodiment, the round brush has an essentially cylindrical area.

In a practical embodiment, it can be provided in addition that the free end of the round brush is essentially hemispherical.

In order to securely hold the arrangement according to the invention when the latter is not installed permanently, at least one suction cup can be provided on the carrier on its side facing away from the round brush. This embodiment allows for a secure attachment of the arrangement according to the invention to essentially freely-selectable spots, for example in tiled rooms.

In order to make it possible to change round brushes for brushes of a different shape and/or brush quality, the round brush can be detachably connected, for example screwed, to the rotary drive. The connection of the round brush to the rotary drive can also be designed as a plug-in coupling or as a coupling such as a bayonet closure.

The feeding of water to the arrangement according to the invention can be done via a permanent connection to a (household) water line or via a connector using a flexible hose (hose such as hoses of hand showers). Advantageously, the arrangement according to the invention can be connected to a shower fixture, in particular to the mixer for setting the temperature of the fed water (thermostat mixer).

The carrier of the arrangement according to the invention can be optionally removably fastened by a fitting panel directly to tiles.

In order to simplify the operation, in particular the start-up and the shutdown of the arrangement according to the invention, a pedal that can be actuated, for example, with a foot can be provided. The pedal is preferably arranged below the round brush and projects from either side and to the front over the round brush, so that it is easily accessible during actuation. For example, by depressing the pedal, a shut-off device is opened, and water flows to the rotary drive and onward to the then rotating round brush. In a preferred embodiment, the, for example, U-shaped pedal is mounted to pivot around a horizontal axis on the carrier, in particular the housing. It can be provided that after being depressed, the pedal (pivoting downward) remains in its position that keeps the shut-off device open. To close the shut-off device, the pedal is raised again (pivoted upward). In a modified embodiment, the pedal is stressed by a spring in its position that corresponds to the closed shut-off device, i.e., in the direction of pivoting upward.

### BRIEF DESCRIPTION OF THE DRAWINGS

Additional details and features of the invention follow from the description below of embodiments of the arrangement according to the invention that are shown diagrammatically in the drawings. Here:

FIG. 1 shows in oblique view an arrangement according to the invention,

FIG. 2 shows an arrangement according to the invention, seen from the front,

FIG. 3 shows an arrangement according to the invention in side view,

FIG. 4 shows an arrangement according to the invention in top view,

FIG. 5 shows an arrangement according to the invention with superposed container in oblique view,

FIG. 6 shows practical examples of the device according to the invention,

FIG. 7 shows another practical example of the device according to the invention,

FIG. 8 shows an arrangement according to the invention that is integrated into a shower panel,

FIG. 9 shows a rotary drive of the arrangement in an exploded diagrammatic view,

FIG. 10 shows an arrangement of the invention combined with a backyard shower,

FIG. 11 shows an embodiment with a foot-actuated pedal in top view,

FIG. 12 shows the embodiment of FIG. 11 in side view,

FIG. 13 shows an arrangement that is combined with a round brush for washing backs, and

FIG. 14 shows the combination of FIG. 13 in side view.

### DESCRIPTION OF THE PREFERRED EMBODIMENTS

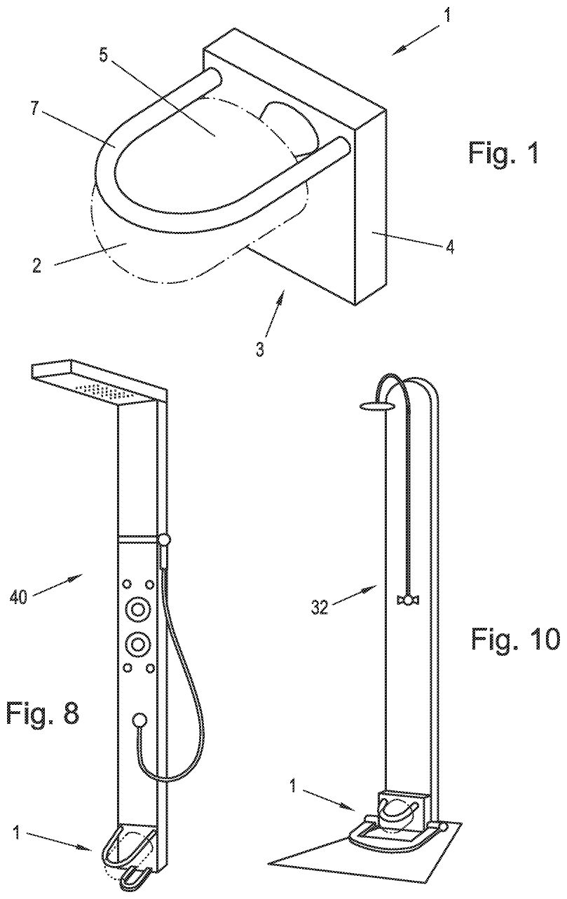

In the embodiment of an arrangement 1 according to the invention, shown in FIG. 1, a round brush 2 is provided, which brush extends from a carrier 3, designed as housing 4 in the embodiment that is shown, and is oriented essentially with a horizontal axis of rotation. The round brush 2 has an essentially cylindrical area 5 and an essentially hemispherical free end 6 that is opposite to the carrier.

On the carrier 3, a stirrup 7 is provided, which stirrup is fastened with its shanks 8 on the carrier 3 that is designed as housing 4. The stirrup 7 has a crosspiece 9 that is bent essentially in the shape of a hemisphere, so that the stirrup 7 has essentially a shape that corresponds to the outline of the round brush 2.

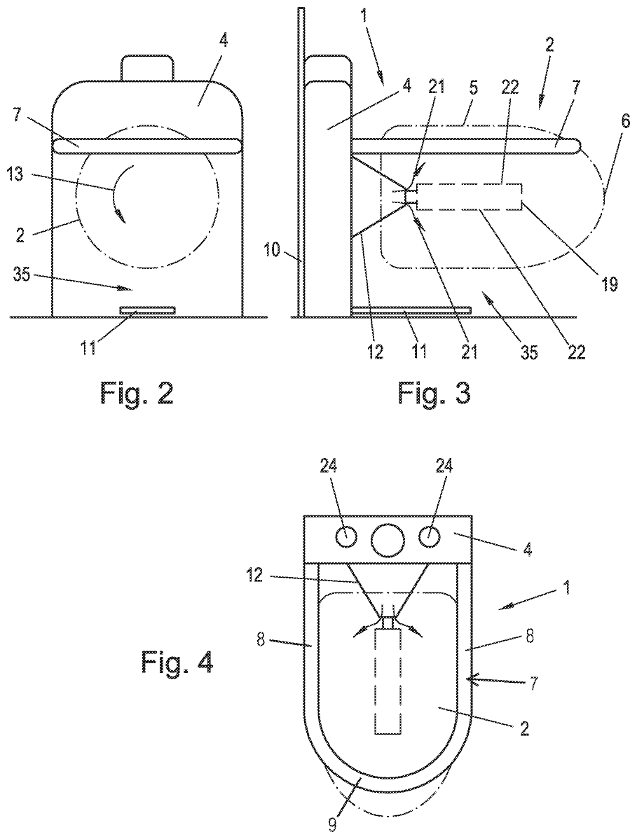

FIGS. 2 and 3 show that the stirrup 7 is arranged so that the upper area of the round brush 2 of the arrangement 1 in the operating position that is shown in FIGS. 1 to 3 projects upward over the stirrup 7, i.e., extends through the inside space of the stirrup 7. In addition, the stirrup 7 is designed and arranged (FIG. 3) in such a way that the front, free, essentially hemispherical end 6 of the round brush 2 projects away from the housing 4 over the crosspiece 9 of the stirrup 7.

In the housing 4 that serves as carrier 3, a plate 10, which is, for example, a plastic-coated metal plate, is provided on the side that faces away from the round brush 2.

The arrangement 1 according to the invention also comprises a base 11 in the embodiment that is shown in FIGS. 1 to 4, via which base the arrangement 1 can be set up on the bottom and, if desired, can be fastened, for example, by screws, or attached by suction cups or by gluing. Also, the base 11 can be designed as a metal plate with plastic coating. There is a free space 35 between the round brush 2 and the base 11 that makes it possible to bring a foot into position between round brush 2 and base 11 (FIG. 6).

The round brush 2 is rotated by a rotary drive 12, as is symbolized by the arrow 13 in FIG. 2. The rotary drive 12 has a motor 14 that is designed, for example, as a turbine and that is operated by water, which is fed at a pressure of 2 to 5 bar, for example from a water line via a connector, which can be provided, for example, on the upper end of the housing 4.

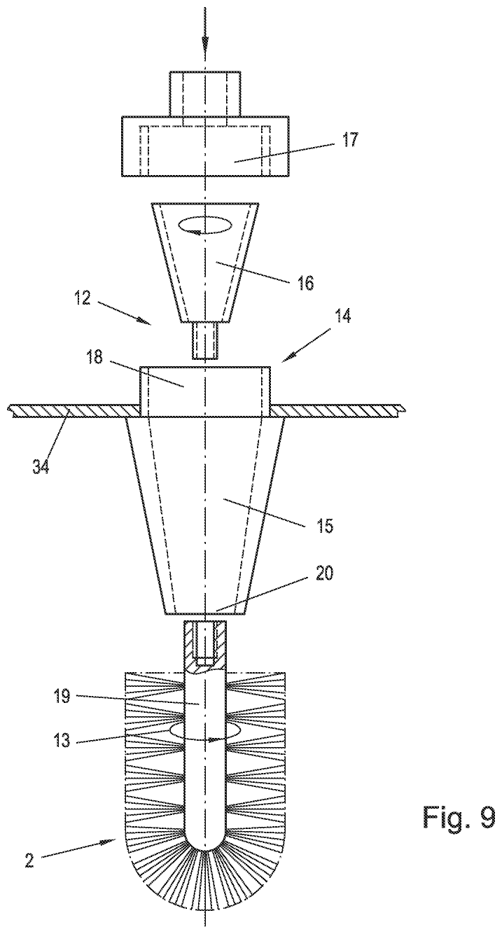

The motor 14 of the rotary drive 12 that is designed in particular as a water turbine has a rotor 16, which is mounted to rotate in a motor housing 15. In the embodiment of the rotary drive 12 that is shown by way of example in FIG. 9, the motor housing 15 is mounted on a wall 34 of the housing 4 by means of a screw nut 17, which is screwed with a threaded attachment 18 of the motor housing 15. The screw nut 17 has a threaded attachment via which a line can be connected for feeding water, which drives the motor 14. In an alternative embodiment, the motor housing 15 is made integral with the wall 34 of the housing 4.

The shaft 19 of the round brush 2 is in particular detachably coupled to the rotor 16 of the motor 14, for example screwed, plugged in or connected via a bayonet-closure-type coupling. Thus, the round brush 2 can be changed, cleaned, sanitized, and/or replaced.

The shaft 19 of the round brush 2 is plugged in through an opening 20, which is provided on the brush-side end of the motor housing 15. In this case, there is play between the shaft 19 and the opening 20, so that water can flow from the motor housing 15 to the round brush 2 (arrow 21 in FIG. 3).

In the embodiment of the rotary drive 12 that is shown in FIG. 9, it is advantageous that water exits from the motor housing 15 through an annular gap, which is bounded inward by the outside of the shaft 19 of the round brush 2 and outward by the inside edge of the opening 20, essentially in the direction of the axis of rotation of the round brush 2 and in the area of the shaft 19 of the round brush 2, and flows toward the round brush 2.

Although not absolutely necessary, the shaft 19 of the round brush 2 can be designed to be hollow, wherein holes 22 are provided in the shaft 19. In this possible embodiment, water that exits through the opening 20 from the motor housing 15 can enter into the inside space of the shaft 19 and flow onward in the direction toward the end 6 of the round brush 2 and can exit from the shaft 19.

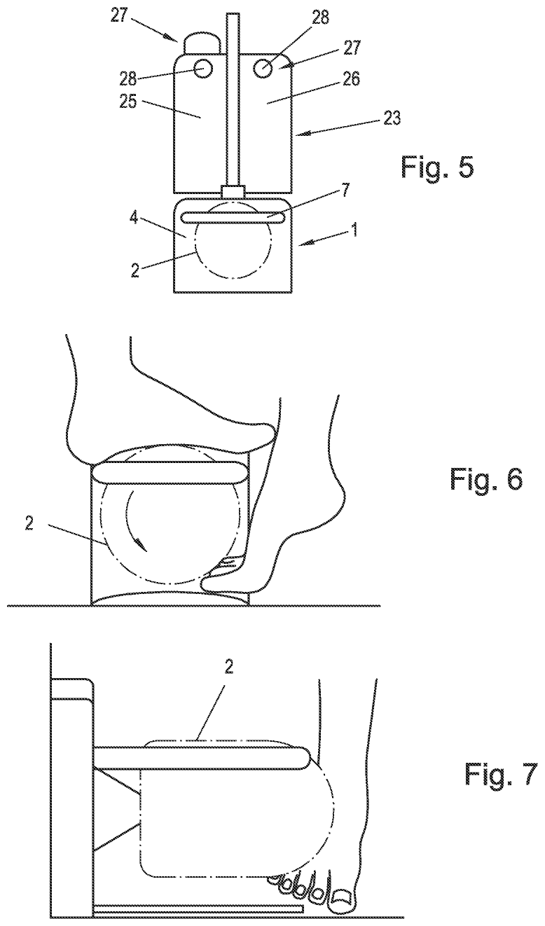

FIG. 5 shows that a container 23 can be superposed on the housing 4 of the carrier 3, and therefore connector openings 24 are provided in the upper end wall of the housing 4. The container 23 can have in particular two spaces 25 and 26. In one space 25, cleaning agent (liquid soap) can be provided, and in the other space 26, a sanitizer can be provided. The connector openings 24 on the upper wall of the housing 4 communicate via lines (not depicted) with the inside space of the stirrup 7 that is designed to be hollow, so that when necessary, sanitizer and/or cleaning agent can be fed to the stirrup 7. Pumps 27, which can be actuated by elastically deformable bellows 28, are assigned to the spaces 25 and 26 of the container 23. Liquid soap or sanitizer can be fed to the stirrup 7 by the pumps 27.

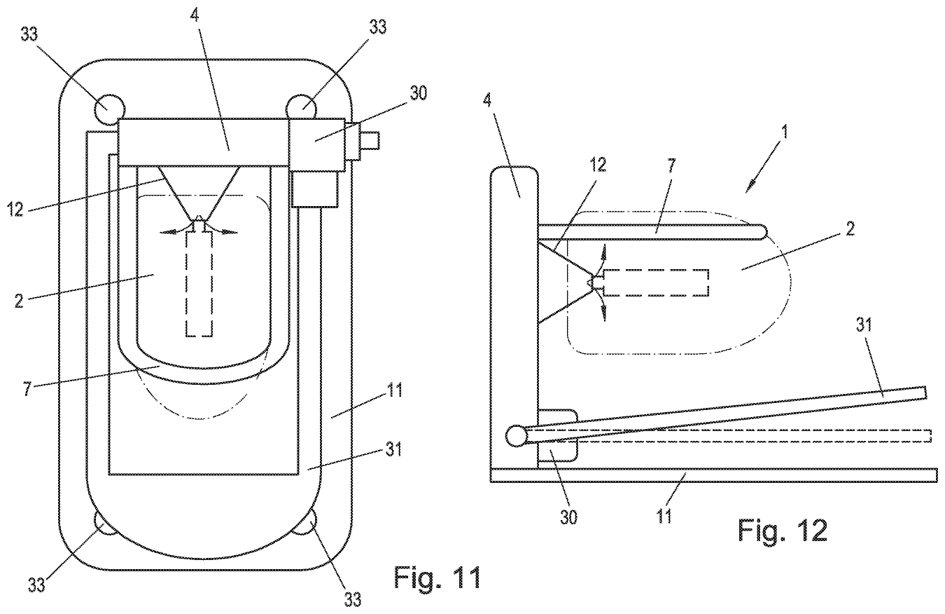

As shown by way of example in FIGS. 11 and 12, a shut-off device 30, which regulates the feeding of water to the rotary drive 12 and onward to the round brush 2, can be provided. The shut-off device 30, for example a valve or a cock, can, as shown in FIGS. 11 and 12, be actuated with a pedal 31. In the embodiment of the arrangement 1 that is shown in FIGS. 11 and 12, the pedal 31 is arranged below the round brush 2 and, when a base 11 is provided, is arranged in the free space 35. As FIG. 11 shows, the frame-like pedal 31 projects from either side and from the front over the round brush 2, so that it is easily accessible, and the round brush 2 does not inhibit the actuation of the pedal 31. The pedal 31 can be pivoted on the carrier 3 around a horizontal axis in the operating position of the arrangement 1. By pivoting the pedal 31 downward, the shut-off device 30 is opened, and by pivoting the pedal 31 upward, it is closed again. The pedal 31 preferably locks in its end positions (shut-off device 30 open or closed), so that it is held in either the “open shut-off device 30” position or the “closed shut-off device 30” position. The position of the “closed shut-off device 30” pedal 31 is indicated by solid lines in FIG. 12, and the position of the “open shut-off device 30” pedal 31 is indicated by dotted lines in FIG. 12.

As an alternative, the pedal 31 can be upright under the action of a spring that places a load on the pedal 31 in its “closed shut-off device 30” position.

The arrangement according to the invention can have a retaining clip, in particular when it is combined with a shower panel (FIGS. 9 and 10). The latter allows an individual using the arrangement to stand up.

In a further development, the retaining clip can be equipped like the pedal 31 for actuating a shut-off device, similar to the shut-off device 30. Thus, the feeding of water to the rotary drive 12 and onward to the round brush 2 can be regulated by pivoting the retaining clip.

In FIG. 6, it is shown how the arrangement 1 according to the invention can be used for cleaning the sole of the foot and for cleaning toes.

FIG. 7 shows how the instep of a foot can be cleaned.

It can be seen that the arrangement 1 according to the invention makes it possible even for individuals with physical disabilities or for individuals who for reasons of age can no longer or not easily reach their feet to wash their feet even without the assistance of third persons.

In this case, it is advantageous that with the arrangement 1 according to the invention, water can be used economically. Even children can easily use the arrangement 1 according to the invention when they want to wash their feet quickly.

In embodiments, the arrangement 1 according to the invention comprises the rotating, horizontal round brush 2 (roller brush) with a rounded free end 6 (head section), wherein the round brush 2 is accessible from the front, from the side, and from above, as well as from the bottom. It is thus possible to clean feet easily from the heel to the toes and also the sole and the instep.

Using a motor 14 that resembles a turbine, which is driven by flowing water, the rotary drive 12 of the round brush 2, preferred within the framework of the invention, produces the effect of a “friction clutch,” which prevents the rotary drive 12 from being damaged when the round brush 2 is unintentionally and inadvertently halted for any reason. This friction clutch also prevents feet or toes from being pinched and injured.

The stirrup 7 that is provided in the arrangement 1 according to the invention acts as a safety stirrup, which prevents the round brush 2 and its shaft 19 from being damaged.

In one embodiment, the round brush 2 can, for example, be unscrewed from the rotor 16 of the motor 14, removed, and changed, so that various brush hardnesses can be used or the round brush 2 can be cleaned, sanitized, and/or replaced. The cleaning and sanitizing of the round brush 2 is important in particular when the device according to the invention is used in hotels or other locations (baths, saunas, etc.) open to the public.

When, in the arrangement according to the invention, a slip-on container 23 that can be filled with sanitizer and liquid soap is provided, an additional improvement of cleaning and subsequent sanitization of feet is produced. For example, it is possible to proceed in such a way that first the feet are washed, and then, after the water is turned off, sanitizer is sprayed onto the round brush 2—and thus also onto the cleaned foot.

The arrangement 1 according to the invention can be easily attached to or integrated into any shower fixture or shower tray. This also makes it possible for the arrangement according to the invention to be integrated into a shower panel 40 (FIG. 8).

The arrangement 1 according to the invention can, as shown by way of example in FIG. 10, be combined with a backyard shower 32, to which water can be fed via a garden hose.

In the base 11 of the carrier 3, for example, holes 33 (fastening eyes) are provided. The holes 33 are preferably provided in the corner areas of an approximately quadrangular base 11. This makes it possible to fasten the arrangement 1 by screws (countersunk heads) to any subfloor (bottom). When the arrangement 1 that is combined with a backyard shower 32 is set up, it can be fastened using screw pegs on the bottom, e.g., in a meadow.

The arrangement 1 according to the invention can also be installed in a shower later. In this case, it can be provided that the arrangement 1 according to the invention is connected via a manually-actuatable manifold valve, such as a three-way valve, to the shower fixture by a flexible hose. In addition, it can be provided that the arrangement 1 according to the invention is attached with one or more suction cups to the tiled floor or to the wall of the shower. Thus, attaching without drilling or mortising is possible.

As an alternative, the arrangement 1 according to the invention can be installed as a concealed device before tile is installed, wherein it is preferred for the visible parts of the arrangement 1 to be matched in color.

The arrangement 1 according to the invention can also be set up in free-standing form outside of a shower, when a corresponding water connector and drain are provided, so that the arrangement according to the invention is also suitable for wheelchair users.

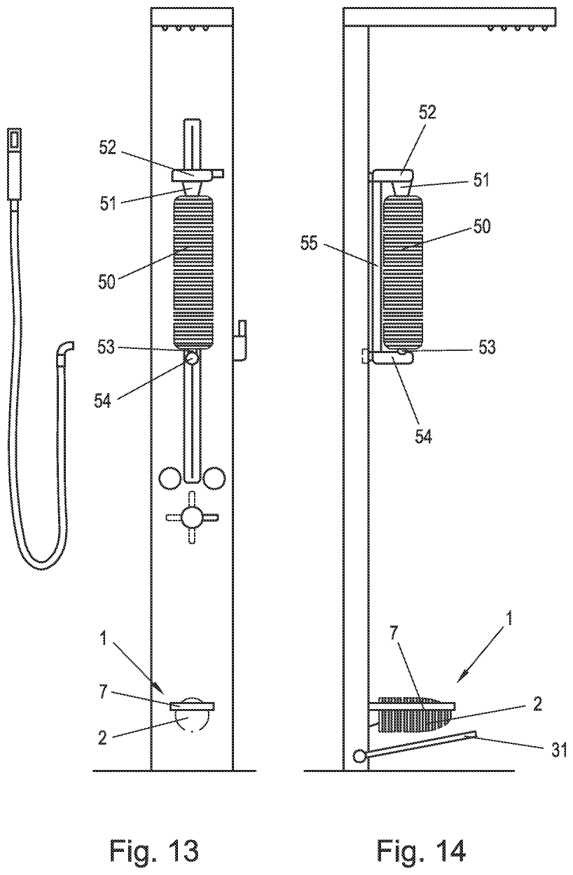

The arrangement 1 according to the invention can be combined with a round brush, driven in rotation around an essentially vertical axis, for washing body parts such as backs or buttocks that are not easily accessible. This combination is shown by way of example in FIGS. 13 and 14. In one shower panel, the arrangement 1 according to the invention is arranged at the bottom with round brush 2, stirrup 7, and pedal 31. Above the arrangement 1, a round brush 50 is mounted in a vertically adjustable manner. The round brush 50 is rotated by, for example, a rotary drive 51 around its vertical axis. The rotary drive 51 can be designed just like the rotary drive 12 of the arrangement 1. In the example that is shown in FIGS. 13 and 14, the rotary drive 51 for the round brush 50 is connected to an upper shank 52, and a storage area 53 for the round brush 50 is connected to a lower shank 54 of a connecting stirrup 55 that is arranged in a vertically adjustable manner on the shower panel.

In summary, an embodiment of the invention can be described as follows:

An arrangement 1 for cleaning feet has a round brush 2 that is driven in rotation. The water-operated rotary drive 12 is arranged on a carrier 3 that is designed as housing 4. Water exits in the area of the shaft of the round brush 2 from the rotary drive 12 to the round brush 2. A U-shaped stirrup 7 is fastened to the housing 4, which stirrup is arranged above the round brush 2 in such a way that the upper area of the round brush 2 projects through the stirrup 7. The feeding of water to the rotary drive 12 is regulated by a shut-off device 3, which is actuated by a pedal 31. The pedal 31 is arranged between a base 11 of the housing 4 and the round brush 2.

1. Arrangement with a round brush, with a rotary drive for the round brush, wherein the rotary drive has a motor, wherein the round brush is arranged with the rotary drive on a carrier, wherein a stirrup is provided on the carrier, and wherein the stirrup is provided in the area of the round brush.

2. The arrangement according to claim 1, wherein the stirrup is an essentially U-shaped stirrup.

3. The arrangement according to claim 2, wherein the stirrup is fastened via the stirrup's shank to the carrier.

4. The arrangement according to claim 2, wherein the crosspiece of the stirrup is curved.

5. The arrangement according to claim 1, wherein in the operating position, the shaft of the round brush is oriented essentially horizontally.

6. The arrangement according to claim 1, wherein the upper part of the round brush projects upward over the stirrup.

7. The arrangement according to claim 1, wherein the free end of the round brush, opposite to the rotary drive, projects over the crosspiece of the stirrup.

8. The arrangement according to claim 1, wherein the stirrup has a width that is essentially equal in value to the diameter of the round brush.

9. The arrangement according to claim 1, wherein the carrier is designed as housing.

10. The arrangement according to claim 1, wherein the carrier has a base.

11. The arrangement according to claim 1, wherein in the operating position, the stirrup is oriented essentially horizontally.

12. The arrangement according to claim 10, wherein there is a free space between the base and the round brush.

13. The arrangement according to claim 9, wherein a connector for water is provided on the housing and wherein a line is provided that runs from the connector to the motor of the rotary drive.

14. The arrangement according to claim 9, wherein a container with at least one space for liquid soap and/or sanitizer is assigned to the housing.

15. The arrangement according to claim 14, wherein the container is removably attached to the housing.

16. The arrangement according to claim 14, wherein the stirrup is hollow, wherein the inside space of the stirrup communicates with the container, and wherein outlet openings are provided in the stirrup.

17. The arrangement according to claim 16, wherein in the operating position, the outlet openings are provided on the lower side of the stirrup.

18. The arrangement according to claim 16, wherein the outlet openings are designed as nozzles or are provided with nozzles.

19. The arrangement according to claim 14, wherein at least one connector for the container is provided on the.

20. The arrangement according to claim 19, wherein at least one line is provided, which line runs from the connector on the housing to at least one shank of the stirrup that is fastened to the housing.

21. The arrangement according to claim 14, wherein the container is equipped with a pump, which can be actuated by a pressing button.

22. The arrangement according to claim 21, wherein the pump has a deformable bellows.

23. The arrangement according to claim 14, wherein the container has a fill opening.

24. The arrangement according to claim 1, wherein the carrier is connected to a plate, which is provided on the side of the carrier that is opposite to the round brush.

25. The arrangement according to claim 24, wherein the stirrup is fastened to the plate.

26. The arrangement according to claim 1, wherein the motor of the rotary drive is a turbine that is driven by flowing water.

27. The arrangement according to claim 1, wherein the motor has a motor housing and a rotor that is mounted to rotate in the motor housing.

28. The arrangement according to claim 27, wherein in the wall of the motor housing, at least one opening is provided, through which water from the motor exits toward the round brush.

29. The arrangement according to claim 28, wherein the opening is the opening, through which the shaft of the round brush engages in the motor housing.

30. The arrangement according to claim 1, wherein the round brush has an essentially cylindrical area.

31. The arrangement according to claim 1, wherein the free end of the round brush is essentially hemispherical.

32. The arrangement according to claim 1, wherein at least one suction cup is provided on the carrier on a side facing away from the round brush.

33. The arrangement according to claim 1, wherein the round brush is detachably connected to the rotary drive.
